(19) United States
(12) Patent Application Publication
(10) Pub. No.: US 2010/0271226 A1
(43) Pub. Date: Oct. 28, 2010

(54) ELECTRICAL OUTLET ARRANGEMENTS AND SYSTEM

(75) Inventor: James D. Holbery, Kirkland, WA (US)

Correspondence Address: SCHWABE, WILLIAMSON & WYATT, P.C., 1420 FIFTH, SUITE 3400, SEATTLE, WA, 98101-4010, US

(73) Assignee: GRID MOBILITY LLC, Kirkland, WA (US)

(21) Appl. No.: 12/769,569

(22) Filed: Apr. 28, 2010

Related U.S. Application Data
(60) Provisional application No. 61/173,503, filed on Apr. 28, 2009.
(60) Provisional application No. 61/173,506, filed on Apr. 28, 2009.
(60) Provisional application No. 61/173,499, filed on Apr. 28, 2009.

(51) Int. Cl. G08B 21/00; G06F 7/04; G06F 1/28

(52) U.S. Cl. 340/657; 340/5.2; 700/295

(57) ABSTRACT

Embodiments of an electrical outlet arrangement and a system formed with a number of the arrangements and a remote control server are disclosed herewith. The arrangements may be configured to encourage usage of electricity generated using renewable sources and/or to enable non-utility entities (NUE) to provide and be compensated for consuming electricity through the NUE are disclosed herein. In various embodiments, an arrangement may include an electrical outlet and a switch coupled with each other. An electrical outlet may be configured to accept electrical coupling from a load for electricity consumption. A switch may be configured to enable or disable electricity flow to the electrical outlet, in response to control of a local controller and/or the remote control server. A local controller may be configured to control one or more switches to enable or disable electricity flow in response to an authentication code and/or a characterization value of the electricity flow, provided to the local controller by a user or the remote control server. Other embodiments may be disclosed and claimed.

### RELATED APPLICATIONS

The present application is a non-provisional application of, and claims priority to the following provisional applications:
(a) U.S. Provisional Application 61/173,503, entitled “ELECTRICAL ENERGY CONSUMPTION CONTROLLER: CONTROL BASED ELECTRON SOURCE(S) WITHIN THE ELECTRIC GRID,” filed Apr. 28, 2009,
(b) U.S. Provisional Application 61/173,506, entitled “ELECTRIC OUTLET THAT OPERATES BASED ON ELECTRON SOURCE INFORMATION WITHIN THE ELECTRICAL GRID,” filed Apr. 28, 2009,
(c) U.S. Provisional Application 61/173,499, entitled “LOCAL AREA POWER DISTRIBUTION AND CONTROL SYSTEM,” filed Apr. 28, 2009.
The specification of these provisional applications are hereby incorporated by reference, to the extent they are consistent with the present specification.

### TECHNICAL FIELD

Embodiments of the present disclosure relate to the field of electricity, more specifically, to an electrical outlet arrangement, and a system formed with a number of the arrangements and a remote control server. The arrangements may be configured to encourage usage of electricity generated using renewable sources and/or to enable non-utility entities (NUE) to provide and be compensated for electricity consumed through the NUE.

### BACKGROUND

With increased concern over climate change, and cost of fossil fuels, there is increased interest in switching to use electricity for energy, e.g., the increased popularity of electric or hybrid vehicles. Also, there is an increased interest in generating and consuming more electricity from renewable sources, such as, wind, solar, hydro, bio mass, and nuclear (which for the purpose of this application, are all considered “renewable sources”). The switching and generating/consuming of electricity from renewable sources have been relatively slow, because in part the lack of mechanisms for consumers to be informed of the generation sources, and for NUE to offer and be compensated for the electricity consumed through the NUE.

### SUMMARY OF INVENTION

Embodiments of an electrical outlet arrangement and a system formed with a number of the arrangements and a remote control server are disclosed herewith. The arrangements may be configured to encourage usage of electricity generated using renewable sources and/or to enable NUE to provide and be compensated for electricity consumed through the NUE are disclosed herein.

In various embodiments, an arrangement may include an electrical outlet and a switch coupled with each other. An electrical outlet may be configured to accept electrical coupling from a load for consumption of electricity. A switch may be configured to enable or disenable electricity flow to the electrical outlet, in response to control provided by a local controller and/or a remote control server. A local controller may be configured to control one or more switches to enable or disable electricity flow in response to an authentication code and/or a characterization value of the electricity flow, provided to the local controller. A remote control server may be configured to control multiple arrangements located in disperse remote locations.

In various embodiments, the authentication code and/or the characterization value may be provided to the local controller by a user via inputs through a user input interface, or by the remote control server via a communication interface. In various embodiments, the local controller may include local verification mask generator configured to generate a verification mask, and a verification circuit configured to verify the authentication code using the locally generated verification mask. In various embodiments, the local controller may include a register configured to store one or more characterization thresholds, and a characteristic checking circuit configured to determine whether the received one or more characteristic values have predetermined relationship with the corresponding one or more stored characteristic thresholds.

In various embodiments, a characterization value may denote a percentage of the electricity flow being generated using one or more renewable sources or a percentage of the electricity flow being generated using fossil fuel. In various embodiments, a display may be provided to display the percentage of the electricity flow being generated using one or more renewable sources or the percentage of the electricity flow being generated using fossil fuel, or both. In various embodiments, a visual indicator may be provided to indicate consumption of electricity flowing through the electrical outlet is being metered and/or charged by a NUE.

In various embodiments, the display and the visual indicator may be disposed on an exterior surface of a housing configured to house the electrical outlet. In various embodiments, the electrical outlet and the switch may be integrally housed by a common housing. In various embodiments, the electrical outlet, the switch, and the controller may be integrally housed by a common housing.

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1 illustrates an overview of the electrical outlet arrangement of the present disclosure, in accordance with various embodiments;

FIG. 2 illustrates the local controller of FIG. 1 in further details, in accordance with various embodiments; and

FIG. 3 illustrates a system of the present disclosure, formed with a number of the arrangements and a remote control server, in accordance with various embodiments.

### DETAILED DESCRIPTION OF ILLUSTRATIVE EMBODIMENTS

Illustrative embodiments of the present disclosure include but are not limited to an electrical outlet arrangement, and a system formed with a number of the arrangements and a remote control server. In various embodiments, the arrangement may be configured to encourage usage of electricity generated using renewable sources and/or to enable NUE to provide and be compensated for electricity consumed through the NUE. Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C) or (A, B and C).” The phrase “(A) B” means “(B) or (A B)”, that is, A is optional.

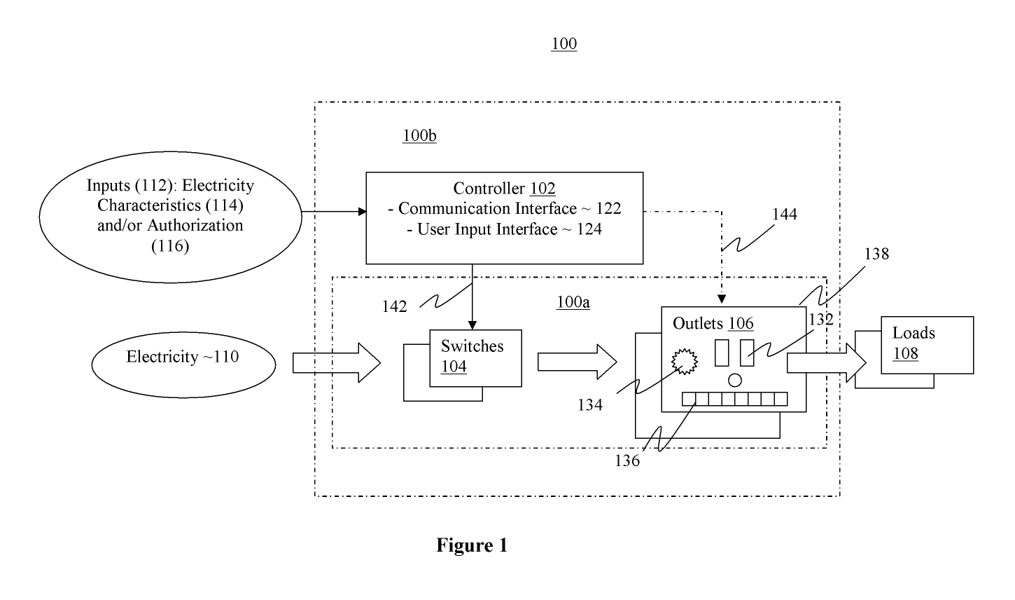

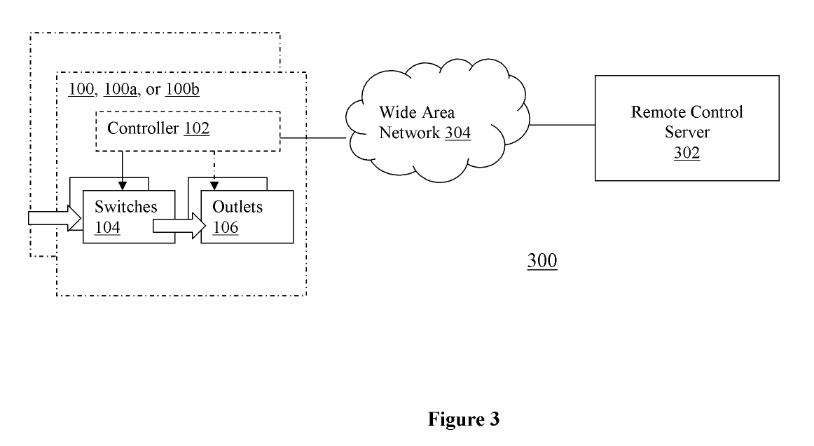

FIG. 1 illustrates an overview of an electrical outlet arrangement, in accordance with various embodiments of the present disclosure. As shown, in various embodiments, electrical outlet arrangement 100 may include one or more electrical outlets 106 and one or more switches 104 electrically coupled with each other. Each electrical outlet 106 may be provided to accept electrical coupling from a corresponding load 108, to consume electricity flow provided to the electrical outlet when electricity flow to the electrical outlet is enabled. The one or more electrical outlets 106 may be electrically coupled with one or more switches 104 configured to enable or disenable electricity flow to the one or more electrical outlets 106, in response to the control of local controller 102 and/or a remote control server (FIG. 3).

Local controller (hereinafter, simply controller) 102 may be communicatively coupled 142 with the one or more local switches (hereinafter, simply switches) 104, and configured to control the one or more switches 104 to enable or disable electricity flow in response to an authentication code and/or a characterization value of the electricity flow, provided to controller 102 by a user or the remote control server.

In various embodiments, the authorization code, when verified, may represent the user having pre-paid or made arrangement for credit for the consumption of electricity by the one or more loads 108. In various embodiments, a characterization value may denote a percentage of the electricity flow being generated using one or more renewable sources or a percentage of the electricity flow being generated using fossil fuel.

Examples of loads may include, but are not limited, home electrical appliances, such as washers, dryers, coffee makers, toasters, televisions, set-top boxes, video cassette recorders (VCR), digital video recorders (DVR), game consoles; personal/professional electrical devices, such as desktop computers, laptop computers, tablet computers, personal digital assistants (PDA), mobile/cell phones; electrical/hybrid vehicles, such as automobiles, snow mobiles, motor homes, motor boats, and so forth. Whereas, examples of renewable sources may include, but are not limited, wind, solar, hydro, bio-mass, nuclear, and the like.

Continuing to refer to FIG. 1, in various embodiments, each electrical outlet 106 may include a socket 132 configured to accept electrical coupling from a corresponding load 108 for consumption of electricity flow provided to the electrical outlet, when provision of electricity flow is enabled. Additionally, in various embodiments, each or a group of electrical outlets 106 may be provided with a display 136, e.g., an array of multi-color LED, including green LED, to display the percentage of the electricity flow being generated using one or more renewable sources or black LED, to display the percentage of the electricity flow being generated using fossil fuel, or both. Further, each or a group of electrical outlets 106 may be provided with a visual indicator 134, e.g., a red light emitting device (LED), configured to provide visual indication to a user that consumption of electricity flow through the electrical outlet(s) 106 is being charged (and/or metered, if permitted) by a NUE.

In various embodiments, visual indicator 134 and display 136 may be disposed on an exterior surface of a housing 138 configured to house one or more of electrical outlets 106. In various embodiments, each or a group of outlets 106 may include a communication interface (not shown) coupling visual indicator 134 and display 136 to controller 102, enabling controller 102 to control visual indicator 134 and display 136. Communication interface may be configured for wired or wireless communication with controller 102.

Still referring to FIG. 1, in various embodiments, an authentication code and/or a characterization value may be provided to controller 102 by a user (not shown) via inputs using user input interface 124, or by a remote control server (FIG. 3) via communication interface 122. Examples of user input interface 124 may include, but are not limited to, a keypad, a touch sensitive screen or a wireless infared (IR) or radio frequency (RF) input interface, such as Bluetooth or Wireless Fidelity (WiFi). Examples of communication interface 122 may include, but are not limited to, wired, such as Ethernet, or wireless, WiFi, Wireless Metropolitan (WiMax), Enhanced Data GMS Environment (EDGE), 3^{rd} generation broadband (3G), 4^{th} generation broadband (4G) or the like. Communication between the remote control server and controller 102 may be in accordance of any one of a number of messaging protocols, including but are not limited, Transmission Control Protocol/Internet Protocol (TCP/IP), Short Messaging Services (SMS), and the like.

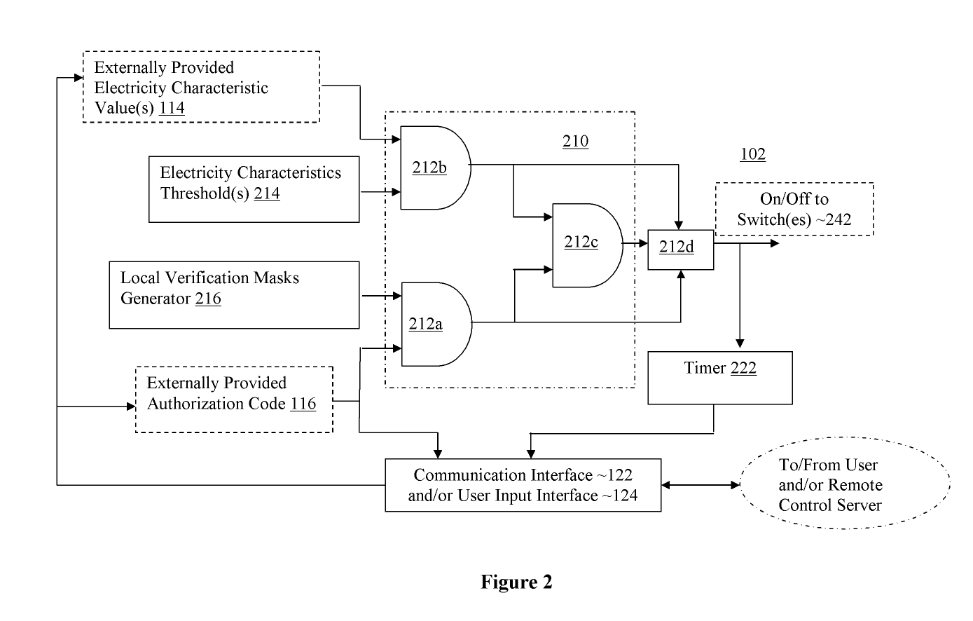

Referring now also to FIG. 2, wherein controller 102 is illustrated in further details, in accordance with various embodiments of the present disclosure. In various embodiments, controller 102, as described earlier, may include communication and/or user input interfaces 122 and/or 124 for receiving an authentication code and/or a characteristic value for the electricity flow from a user and/or a remote control server.

In various embodiments, controller 102 may further include a local verification mask generator 216 configured to generate a verification mask, and a control circuit 212 having verification circuit 212a configured to verify the externally provided authentication code 116 using the locally generated verification mask. In various embodiments, authentication code may be credit card numbers, and verification masks may be valid credit card number formats. In other embodiments, authentication code and verification mask may be symmetric keys instead.

In various embodiments, authentication code, may further include information indicating whether electricity flow should be enabled for a pre-determined finite amount of time (e.g., 15 minutes, 30 minutes, an hour and so forth) or an indefinite amount of time, such as until a consumption of electricity has discontinued for a predetermined amount of time after consumption started (e.g., electricity draw stopped for 1 minute after drawing started, in the case of charging a load, such as an electric/hybrid vehicle).

For the latter embodiments allowing consumption for an indefinite amount of time, controller 102 may further include timer or counter 222 to track an amount of electricity consumed. For these embodiments, controller 102 may further report the amount of consumption to a remote control server, such that the consumption party may be properly debited or billed for the amount of electricity consumed, and the NUE providing the electricity flow may be properly credited.

In various embodiments, controller 102 may include a register 214 configured to store one or more electricity characterization thresholds, and control circuit 212 may further include a characteristic checking circuit 212b configured to determine whether a received characteristic value 114 has a predetermined relationship with a corresponding stored characteristic threshold 214, e.g., whether a received characteristic value 114 denoting a percentage of the electricity flow is being generated using renewable sources exceeds a corresponding stored characteristic threshold 214, thereby allowing certain electricity consumption to occur only if the current electricity flow reaches at least a desired level of generation from renewable sources.

In various embodiments, control circuit 212 may further include compare circuit 212c and multiplexer 212d to enable controller 102 to generate control (on/off) signal 242 for the one or more switches 104 to control the electricity flow to the one or more outlets 106, based on either the result of authentication code verification, or the characteristics of the electricity flow, or both.

Referring principally to FIG. 1 again, in various embodiments, electrical outlets 106 with display 136 may be standalone units. In other embodiments, one or more switches 104 may be integrally housed with one or more electrical outlets 106 respectively using corresponding one or more housings 138 or by a common housing (as denoted by the arrangement 100a depicted using the inner dotted lines in FIG. 1). In other words, in the latter embodiments, as an example, multiple electrical outlets 106 and a single switch 104 may be integrated in a single housing 100a, with the single switch 104 regulating electricity flow to all the integrally housed electrical outlets 106. In various ones of these embodiments, the single switch 104 may be directly coupled to controller 102 or via wired local area network (LAN) coupling or a wireless coupling. The integral arrangement may be provided with an appropriate communication/coupling interface. In still other embodiments, one or more electrical outlets 106, one or more switches 104, and controller 102 may all be integrally housed by a common housing. (as denoted by the arrangement 100b depicted using the outer dotted lines in FIG. 1).

Standalone embodiments 106 (without visual indicators 134) are particularly useful for home applications, to encourage users to consume electricity when a high percentage of the electricity flow is generated from renewable sources.

Embodiments 100a with a number of switches 104 integrally housed with a number of electrical outlets 106 respectively, using corresponding number of housings 138, complemented with a controller 102 configured to wirelessly control switches 104 are particularly useful for local or proximate control applications, e.g., in an airplane application, allowing an airline to recover the cost for providing outlets 106 at the seats, and electricity to outlets 106. An attendant may use controller 102 to wirelessly enable electricity for an amount of time or for the entire duration of a flight, upon having received payment or arrangement for payment from the respective passengers.

Embodiments 100b with outlets 106, one or more switches 104 and a controller integrally housed are particularly useful for remote control or self server applications. Examples of remote control applications may include, but are not limited to, e.g., a dock application, wherein a dock operator may employ embodiments 100b to recover the cost for providing outlets 106 at the slips, and electricity to outlets 106. An operator may remotely interact with controller 102 to enable electricity flow to selected ones of outlets 106 for various period of time/charge or for an indefinite charge, upon having received payment or arrangement for payment from the respective users. Examples of self-service applications may include, but are not limited to, e.g., a vehicle charging stations, wherein the vehicle charging station operator may employ embodiments 100b to recover the cost for providing outlets 106 at the station, and electricity to outlets 106. A user may cause controller 102 to enable electricity flow to a selected one of outlets 106 for a period of time/charge or for an indefinite charge, upon having providing an appropriate authorization code conveying to controller that the user has arranged for payment or credit for the electricity to be consumed.

Referring now to FIG. 3, wherein a system formed with a number of the electrical outlet arrangements and a remote control server, in accordance with various embodiments, is shown. As illustrated, in various embodiments, system 300 may comprise remote control server 302 and a number of electrical outlet arrangements 100, 100a or 100b, coupled with each other, via wide area network 304. Electrical outlet arrangements 100, 100a or 100b may be any one of the earlier described embodiments, and may be located in a number of dispersed locations. Network 304 is intended to represent a broad range of wired or wireless, private and/or public networks, e.g., the Internet. Remote control server 302 may be configured to remotely and selectively control electrical outlet arrangements 100, 100a, 100b, enabling or disabling electrical outlet arrangements 100, 100a, 100b from providing electricity for consumption by respective loads. The control may be based on various factors, including but are not limited to current electricity generation sources, as described earlier, credit and/or payment arrangement of the potential electricity consumers, system loads, and so forth. Remote control server 302 may also be configured to collect, aggregate and/or report on various metrics and data. Remote control server 302 is intended to represent a broad range of servers known in the art, e.g., servers available IBM of Armonk, N.Y., Dell Computer, Inc., of Austin, Tex., or Hewlett Packard of Palo Alto, Calif. The logic to configure remote control server 302 may be implemented using any one of a number of programming languages known in the art, C, C++, Java™, XML and so forth.

Although specific embodiments have been illustrated and described herein, it will be appreciated by those of ordinary skill in the art that a wide variety of alternate and/or equivalent implementations may be substituted for the specific embodiments shown and described, without departing from the scope of the present disclosure. This application is intended to cover any adaptations or variations of the embodiments discussed herein. Therefore, it is manifestly intended that this disclosure be limited only by the claims and the equivalents thereof.

What is claimed is:

1. An electrical apparatus comprising:
an electrical outlet configured to provide electricity from an external electricity source to a load electrically coupled with the electrical outlet;
a display including a plurality of light emitting diodes configured to display a percentage of the electricity flow being generated using one or more renewable sources or a percentage of the electricity flow being generated using fossil fuel, or both; and
a housing configured to house the electrical outlet, including an exterior surface to host the visual indicator and the display.

2. The electrical apparatus of claim 1, further comprising a communication interface housed by the housing, and configured to couple the display to an externally disposed controller configured to control the visual indicator the display.

3. The electrical apparatus of claim 1, further comprising a switch coupled with the electrical outlet, housed by the housing, and configured to enable or disable electricity flow to the electrical outlet, in response to control of a controller, wherein the controller is configured to control the switch to enable or disable the electricity flow based at least in part on a characterization value provided to the controller, wherein the characterization value denotes a percentage of the electricity flow being generated using one or more renewable sources or a percentage of the electricity flow being generated using fossil fuel.

4. The electrical apparatus of claim 3, further comprising a visual indicator housed by the housing and configured to indicate consumption of electricity through the electrical outlet is being metered and charged by a non-utility entity, wherein the controller is further configured to control the switch based on an authorization code provided to the controller.

5. An electrical apparatus comprising:
an electrical outlet configured to accept electrical coupling from a load;
a switch coupled to the electrical outlet and configured to enable a controller to enable or disable electricity flow from an external electricity source to the electrical outlet for usage by the load, based on an authorization code or a characterization value of the electricity flow provided to the controller; and
a housing configured to integrally house the electrical outlet and the switch.

6. The electrical apparatus of claim 5, further comprising the controller, and the housing is further configured to integrally house the controller.

7. The electrical apparatus of claim 5, wherein the controller is external to the apparatus, and the apparatus further comprises a communication interface coupled with the switch, disposed within the housing, and configured to receive a control signal, from the controller, for the switch.

8. The electrical apparatus of claim 5, wherein the characterization value denotes a percentage of the electricity flow being generated using one or more renewable sources or a percentage of the electricity flow being generated using fossil fuel.

9. An electrical apparatus comprising:
an electrical outlet configured to accept electrical coupling from a load;
a switch coupled to the electrical outlet and configured to enable or disable electricity flow from an external electricity source to the electrical outlet for usage by the load; and
a controller coupled to the switch and configured to control the switch to control the enabling and disabling of the electricity flow, based on at least one of an authorization code or a characterization value of the electricity provided to the controller.

10. The electrical apparatus of claim 9, wherein the controller comprises a communication interface or a user input interface configured to receive the authorization code or the characterization from a remotely located control server or a proximately located user.

11. The electrical apparatus of claim 10, wherein the communication interface comprises a selected one of a wireless wide area networking interface or a wireless personal networking interface.

12. The electrical apparatus of claim 10, wherein the user input interface comprises a selected one of a keypad or a touch sensitive screen.

13. The electrical apparatus of claim 9, wherein the controller comprises a local verification mask generator configured to locally generate a verification mask, and a verification circuit coupled to the local verification mask generator to compare the received authorization code with the locally generated verification mask, and the controller is configured to enable the electricity flow only if the verification circuit is able to verify the authentication code using the locally generated verification mask.

14. The electrical apparatus of claim 13, wherein the authorization code comprises a credit card number, and the verification mask comprises a credit card number format.

15. The electrical apparatus of claim 13, wherein the authorization code and the verification mask are symmetric keys.

16. The electrical apparatus of claim 9, wherein the controller comprises a register configured to store a characteristic threshold, and a characteristic checking circuit coupled to the register to compare the received characteristic with the stored characteristic threshold, and the controller is configured to enable the electricity flow only if the received characterization value has a predetermined relationship with the stored characteristic threshold.

17. The electrical apparatus of claim 9, wherein the characterization value denotes a percentage of the electricity flow being generated using one or more renewable sources or a percentage of the electricity flow being generated using fossil fuel.

18. The electrical apparatus of claim 17, further comprising a display coupled with the controller and configured to display the percentage of the electricity flow being generated using one or more renewable sources or the percentage of the electricity flow being generated using fossil fuel, or both.

19. The electrical apparatus of claim 17, further comprising a visual indicator coupled with the controller and configured to indicating consumption of electricity through the electrical outlet is being metered and billed by a non-utility entity.

20. An electrical apparatus comprising:
a plurality of electrical outlets configured to accept electrical coupling from a corresponding plurality of loads;
one or more switches coupled to the electrical outlets and configured to enable or disable electricity flow from an external source to the electrical outlets for usage by the loads; and
a controller coupled to the one or more switches and configured to control the one or more switches to control the enabling and disabling of the electricity flow, based on at least one of an authorization code or a characterization value of the electricity provided to the controller.

21. The electrical apparatus of claim 20, wherein the one or more switches consist of one single switch coupled with the electrical outlets, wherein the controller is configured to control the enabling and disabling of the electricity flow to the plurality of electrical outlets through the one single switch.

22. The electrical apparatus of claim 20, wherein the one or more switches comprise a plurality of switches correspondingly integrated with the electrical outlets, wherein the controller is configured to selectively control the enabling and disabling of the electricity flow to the plurality of electrical outlets through the corresponding switches.

23. The electrical apparatus of claim 20, wherein the controller and the one or more switches comprise respective networking interfaces, and the controller and the one or more switches are coupled with each other via a local area network.

24. The electrical apparatus of claim 23, wherein the local area network is a selected one of a wire or a wireless network.

25. A system comprising:
a plurality of electrical apparatuses, wherein each electrical apparatus includes
one or more electrical outlets configured to accept electrical coupling from corresponding one or more loads; and
one or more switches coupled to the electrical outlets and configured to enable or disable electricity flow from an external source to the electrical outlets for usage by the one or more loads; and
a server remotely disposed and coupled with the plurality of electrical apparatuses, and configured to selectively control the one or more switches of the electrical apparatuses to respectively control the enabling and disabling of the electricity flow to the one or more electrical outlets of the electrical apparatuses.

26. The system of claim 25, wherein at least two of the electrical apparatuses are remotely disposed from each other.

27. The system of claim 25, wherein at least a first of the electrical apparatus further comprises a local controller coupled to the one or more switches of the first electrical apparatus, and configured to control the one or more switches of the first electrical apparatus to control the enabling and disabling of the electricity flow to the one or more electrical outlets of the first electrical apparatus, in response to control received from the remote control server.

28. The system of claim 27, wherein the server and the local controller comprise respective networking interfaces, and the server and the local controller are coupled with each other via a wide area network.

29. The system of claim 28, wherein the wide area network comprises a selected one of a wire or a wireless network.
